(19) United States
(12) Patent Application Publication
(10) Pub. No.: US 2006/0134366 A1
(43) Pub. Date: Jun. 22, 2006

(54) Substrate materials for transparent injection-molded parts

(75) Inventors: Wilfried Haese, Odenthal (DE); Burkhard Reitze, Bergisch Gladbach (DE); Alexander Meyer, Dusseldorf (DE); Michael Prein, Krefeld (DE); Friedrich-Karl Bruder, Krefeld (DE); Michael Roppel, Burscheid (DE); Matthias Voetz, Koln (DE); Dieter Ruhle, Odenthal (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/312,013

(22) Filed: Dec. 20, 2005

(30) Foreign Application Priority Data
Dec. 22, 2004 (DE) 102004061753.8

(51) Int. Cl. B32B 3/02; C08G 64/00

(52) U.S. Cl. 428/64.1; 528/196

(57) ABSTRACT

A polymeric material suitable for making a substrate for optical data storage disks is disclosed. The material, preferably aromatic polycarbonate is characterized in that the potential on 95 to 100% of the total surface of a disk molded therefrom is from −1.5 to +1.5 kV, and in that the potential on 0 to 5% of the total surface of said disk is between −1.5 and −2.5, and +1.5 to +2.5, and in that the potential on no more than 1% of the total surface of said disk is less than −2.5 kV and more than +2.5 kV. The potential measurements are carried out by means of a Monroe probe at a distance of 3.5 mm from the surface of the disk, the scanning region is in each case 12 cm in the X- and Y-direction, and in each case in steps of 2 mm in the X- and in the Y-directions.

### FIELD OF THE INVENTION

The invention is directed to a polymeric material and in particulars to materials suitable for making optical data storage media.

### TECHNICAL BACKGROUND OF THE INVENTION

The present invention provides materials as substrate material for the production of transparent injection-molded parts, in particular for the production of injection-molded parts and moldings which are to be coated and are obtainable from these materials. Moldings may be e.g. transparent sheets, lenses, optical storage media or carriers for optical storage media or also articles from the automotive glazings sectors, such as e.g. diffusing screens. The present invention provides, in particular, optical storage media and carriers for optical storage media, such as e.g. writable optical data storage media which have a good coatability and wetting capacity and are suitable e.g. for application of dyestuffs from solution, in particular from non-polar media. The optical injection-molded parts from the materials, especially polycarbonates, according to the invention furthermore have a relatively low tendency towards soiling.

Transparent injection-molded parts are of importance above all in the glazings and storage media sector.

Optical data recording materials are increasingly being used as a variable recording and/or archiving media for large amounts of data. Examples of this type of optical data storage media are CD, super-audio-CD, CD-R, CD-RW, DVD, DVD-R, DVD+R, DVD-RW, DVD+RW and BD.

Transparent thermoplastics, such as, for example polycarbonate, polymethyl methacrylate and chemical modifications thereof, are typically employed for optical storage media. Polycarbonate as a substrate material is suitable, in particular, for optical disks which are writable once and readable several times and also for those which are writable several times, and for the production of moldings from the automotive glazing sector, such as e.g. diffusing screens. This thermoplastic has an excellent mechanical stability, has a low susceptibility to changes in dimensions and is distinguished by a high transparency and impact strength.

DE-A 2 119 799 disclosed the preparation of polycarbonates having phenolic end groups, by the phase interface process and also the process in a homogeneous phase.

Polycarbonate prepared by the phase interface process may be used for the production of optical data storage media of the formats described above, such as e.g. for compact disks (CD) or digital versatile disks (DVD). These disks often have the property of building up a high electrical field during their production in the injection molding process. This high field strength on the substrate during production of the optical data storage media leads e.g. to attraction of dust from the environment or to sticking of the injection-molded articles, such as e.g. the disks, to one another, which reduces the quality of the finished injection-molded articles and makes the injection molding process difficult.

It is furthermore known that electrostatic charging, in particular of disks (for optical data carriers), leads to a lack of wettability, above all with non-polar media, such as e.g. a non-polar dyestuff or a dyestuff application from solvents, such as e.g. dibutyl ether, ethylcyclohexane, tetrafluoropropanol, cyclohexane, methylcyclohexane or octafluoropropanol. Thus, a high electrical field on the surface of the substrate during the application of dyestuffs on writable data storage media causes, for example, an irregular coating with dyestuff and therefore leads to defects in the information layer.

The degree of electrostatic charging of a substrate material may be quantified e.g. by measurement of the electrical field at a particular distance from its surface.

In the case of an optical data storage medium in which a writable substrate is applied to the surface in a spin coating process, a low absolute electrical field strength is necessary in order to obtain uniform application of the writable layer and a trouble-free production process.

Because of the facts described above, a high electrostatic field moreover causes losses in yield in respect of the substrate material. This may lead to interruptions in the particular production step and is associated with high costs.

Several paths have been followed to solve this problem of high static charging. In general, antistatics are added to the substrate material as additives. Antistatic polycarbonate compositions are described e.g. in JP 62 207 358-A. In this specification, phosphoric acid derivatives, inter alia, are added to the polycarbonate as antistatics. EP 0922 728 describes various antistatics, such as polyalkylene glycol derivatives, ethoxylated sorbitan monolaurate, polysiloxane derivatives, phosphine oxides and distearylhydroxyamine, which are employed individually or as mixtures. The Japanese Application JP 62 207 358 describes esters of phosphorous acid as additives. U.S. Pat. No. 5,668,202 describes sulfonic acid derivatives. U.S. Pat. Nos. 6,262,218 and 6,022,943 describe the use of phenyl chloroformate in order to increase the end group content in melt polycarbonate. According to these, an end group level greater than 90% is said to have a positive effect on the electrostatic properties. In WO 00/50 488, 3,5-di-tert-butylphenol is employed as a chain terminator in the phase interface process. This chain terminator leads to a lower static charging of the corresponding substrate material compared with conventional chain terminators. JP 62 207 358-A describes polyethylene derivatives and polypropylene derivatives as additives for polycarbonate. EP-A 1 304 358 describes the use of short oligomers, such as e.g. bisphenol A bis-(4-tert-butylphenyl carbonate) in polycarbonate from the transesterification process.

However, the additives described may also have an adverse effect on the properties of the material, since they tend to migrate from the material. This is indeed a desirable effect for the antistatic properties, but may lead to formation of surface deposits or defective molding. The content of oligomers in the polycarbonate may moreover also lead to a poorer level of mechanical properties and to a lowering of the glass transition temperature. These additives may furthermore cause side reactions. Subsequent “end-capping” of polycarbonate which has been obtained from the transesterification process is expensive and the results achieved are lacking. The introduction of new end groups into the material is associated with high costs.

The object is therefore to provide material that meets the requirements of a lowest possible potential (value) in combination with low potential differences on the substrate surface (measured at a certain distance from the substrate surface) and avoids the disadvantages described above.

Those substrate materials which include little or no additives are most advantageous. Thus e.g. the antistatics described in EP-A 922 728, such as polyoxyethylene sorbitan monolaurate, polyoxyethylene monolaurate and polyoxyethylene monostearate, are indeed active in respect of the antistatic properties in the amounts added, of 50-200 ppm, but may be a disadvantage for the overall performance of the injection-molded article, as described above.

The material may however include known additives, e.g. flameproofing agents, mold release agents, UV stabilizers and heat stabilizers. Nevertheless, the amount of additives employed is to be kept as low as possible for the reasons described above. Examples of such additives that are suitable in the context of polycarbonates are mold release agents based on stearic acid and/or stearyl alcohol, particularly preferably pentaerythritol stearate, trimethylolpropane tristearate, pentaerythritol distearate, stearyl stearate and glycerol monostearate, as well as heat stabilizers based on phosphanes, phosphites and phosphoric acid.

### SUMMARY OF THE INVENTION

A polymeric material suitable for making a substrate for optical data storage disks is disclosed. The material, preferably aromatic polycarbonate, is characterized in that the potential on 95 to 100% of the total surface of a disk molded therefrom is from −1.5 to +1.5 kV, and in that the potential on 0 to 5% of the total surface of said disk is between −1.5 and −2.5, and +1.5 to +2.5, and in that the potential on no more than 1% of the total surface of said disk is less than −2.5 kV and more than +2.5 kV. The potential measurements are carried out by means of a Monroe probe at a distance of 3.5 mm from the surface of the disk, the scanning region is in each case 12 cm in the X- and Y-direction, and in each case in steps of 2 mm in the X- and in the Y-directions.

### BRIEF DESCRIPTION OF THE FIGURES

FIG. 1 shows the charge distribution of a disk molded of the inventive polycarbonate.

FIG. 2 shows the charge distribution of a disk molded of a material failing to meet the inventive criteria.

### DETAILED DESCRIPTION OF THE INVENTION

The present invention provides material which may be used in making rewritable optical data carriers having a good writability and wettability and low tendency towards soiling. The material according to the invention leads to a low rate of rejects in the production process.

It has been found, surprisingly, that the materials which are suitable for the production of transparent moldings which are to be coated are, in particular, those which, after processing to the injection-molded part, show a particularly defined distribution of potential on the surface of the injection-molded part. This distribution of potential may be determined, for instance by rendering it visible by an imaging process, e.g. with the aid of a so-called Monroe probe. It has been found that injection-molded parts which feature low value and homogeneous distribution of the potential are of advantage. This was not known to date and is an important criterion for the quality of a molding. Thus e.g. disks which have a low value of the potential in combination with as homogeneous as possible a distribution of the potential on the surface are of particular advantage for rewritable optical data storage media.

As a decisive quality feature for the coating of injection-molded parts, in particular for the coating of transparent optical disks or of transparent diffusing screens, it has therefore been found, surprisingly, that substrate materials which have a positive effect in the context of the invention are mostly those which, after an injection molding process, lead to transparent moldings which have as low as possible a value of the potential in combination with a homogeneous distribution of the potential, measured at a defined distance from the substrate surface and at a defined temperature and atmospheric humidity.

The present invention concerns a polymeric material, preferably polycarbonate, suitable for the production of transparent injection-molded articles, especially substrates suitable for coating, wherein 95-100% of its total surface of a disk obtained by injection molding has potential ranges of between −1.5 and +1.5 kV, and up to 5% of the surface has charge ranges of between −1.5 and −2.5 or between +1.5 and +2.5 kV and no more than 1% of the surface has charge that is less than −2.5 or greater than 2.5 kV.

Materials having these properties e.g. may be coated particularly well with non-polar media, such as e.g. with dyestuffs dissolved in organic solvents. The injection molding to be coated is preferably a diffusing screen or a carrier material for an optical writable data storage medium.

A measure which may serve for the homogeneity of the electrical charge distribution on the disk surface is e.g. the standard deviation of the potential (of certain disk segments) resulting from the electrical charging. Preferably, the standard deviation of the potential in the surface segments resulting from the electrical charging should not exceed 0.6 kV.

A surface which has a potential range of from −1.5 kV to +1.5 kV, i.e. which has no or only low potentials, is particularly preferred. In this case, only the surface of the injection-molded article is relevant, i.e. in the case of, for example, a CD or DVD, only the region up to the stacking ring and not the inner hole region.

The electrical potential caused by surface charges on the corresponding substrate substantially depends on the geometry and the dimensions of the injection-molded article and the nature of the injection molding process. It is therefore important to carry out the measurement on the injection-molded article, which is to be coated, itself, such as e.g. a disk for an optical data carrier.

All the values described above and measured apply to moldings which have been produced via an injection process, which is known in principle, at a certain atmospheric humidity and room temperature without the use of ionizers.

In order to ensure a good writability of the disks in the production process, so-called ionizers which conduct a stream of ionized air over the disks are often employed. The abovementioned measurement values for substrate materials according to the invention have been achieved without the use of ionizers. This is a further advantage of the invention, since the use of ionizers makes the production process more expensive. Nevertheless, ionizers may additionally be employed.

The present invention also provides the moldings produced from the substrate materials according to the invention, such as e.g. disks for writable optical data storage media or materials from the automotive glazings sectors, such as e.g. diffusing screens.

Materials which are suitable for the production of the coatable transparent injection-molded parts, preferably optical data storage media, are:

Thermoplastics, such as polycarbonate, especially polycarbonate based on bisphenol A (BPA-PC) and polycarbonate based on trimethyl-cyclohexyl-bisphenol polycarbonate (TMC-PC), fluorenyl polycarbonate, polymethyl methacrylate, cyclic polyolefin copolymer, hydrogenated polystyrenes (HPS) as well as amorphous polyolefins and polyesters.

The substrate materials according to the invention and injection-molded articles obtainable therefrom, in particular disks, may be produced by the choice of suitable process parameters.

The charge distribution on an injection-molded article which is obtained after processing of the substrate material may be influenced by several factors. For example, the purity of the educts and auxiliary substances is of importance. Furthermore, process parameters such as the molar ratio of the bisphenol employed and phosgene, temperatures during the reaction, reaction and dwell times, may be decisive. For the person skilled in the art, the object is to control the process such that a substrate material which generates the desired charge distribution on the injection-molded article is provided. The instrumented measurements of the charge and its distribution are recognized by the art-skilled as suitable for controlling the process.

A suitable choice of process parameters in the present context, relative to polycarbonates, is represented as follows:

While in the conventional process for making polycarbonate the excess of phosgene used, based on the total of bisphenols employed, is between 3 and 100 mol %, preferably between 5 and 50 mol %, the substrate material according to the invention is prepared at phosgene excesses of from 5 to 20 mol %, preferably 8 to 17 mol %. In this context, the pH of the aqueous phase during and after the metering of the phosgene is kept in the alkaline range, preferably between 8.5 and 12, by subsequent metering of sodium hydroxide solution once or several times or appropriate subsequent metering of bisphenolate solution, while it is adjusted to 10 to 14 after addition of the catalyst. The temperature during the phosgenation is 0° C. to 40° C., preferably 5° C. to 36° C.

Polycarbonates suitable in the context of the invention may be prepared by the phase interface process. This process for polycarbonate synthesis is described in many instances in the literature; reference may be made by way of example to H. Schnell, Chemistry and Physics of Polycarbonates, Polymer Reviews, vol. 9, Interscience Publishers, New York 1964 p. 33 et seq., to Polymer Reviews, vol. 10, “Condensation Polymers by Interfacial and Solution Methods”, Paul W. Morgan, Interscience Publishers, New York 1965, chap. VIII, p. 325, to Dres. U, Grigo, K. Kircher and P. R. Müller “Polycarbonate” in Becker/Braun, Kunststoff-Handbuch, vol. 3/1, Polycarbonate, Polyacetale, Polyester, Celluloseester, Carl Hanser Verlag Munich, Vienna 1992, p. 118-145 and to EP-A 0 517 044.

According to this process, the phosgenation of a disodium salt of a bisphenol (or of a mixture of various bisphenols) which has been initially introduced into an aqueous-alkaline solution (or suspension) is carried out in the presence of an inert organic solvent or solvent mixture which forms a second phase. The oligocarbonates formed, which are chiefly present in the organic phase, are subjected to further condensation with the aid of suitable catalysts to give high molecular weight polycarbonates dissolved in the organic phase. Finally, the organic phase is separated off and the polycarbonate is isolated therefrom by various working up steps.

Dihydroxyaryl compounds which are suitable for the preparation of polycarbonates are those of the formula (2)
HO—Z—OH (2)

in which
Z is an aromatic radical having 6 to 30 C atoms, which may contain one or more aromatic nuclei, may be substituted and may contain aliphatic or cycloaliphatic radicals or alkylaryls or heteroatoms as bridge members.

Preferably, Z in formula (2) represents a radical of the formula (3)

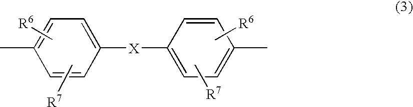

in which
R⁶ and R⁷ independently of one another represent H, C₁-C₁₈-alkyl, C₁-C₁₈-alkoxy, halogen, such as Cl or Br, or in each case optionally substituted aryl or aralkyl, preferably H or C₁-C₁₂-alkyl, particularly preferably H or C₁-C₈-alkyl, and very particularly preferably H or methyl, and
X represents a single bond, —SO₂—, —CO—, —O—, —S—, C₁- to C₆-alkylene, C₂- to C₅-alkylidene or C₅- to C₆-cycloalkylidene, which may be substituted by C₁- to C₆-alkyl, preferably methyl or ethyl, and furthermore C₆- to C₁₂-arylene, which may optionally be fused with further aromatic rings containing heteroatoms.

Preferably, X represents a single bond, C₁ to C₅-alkylene, C₂ to C₅-alkylidene, C₅ to C₆-cycloalkylidene, —O—, —SO—, —CO—, —S—, —SO₂—,

or a radical of the formula (3a) or (3b)

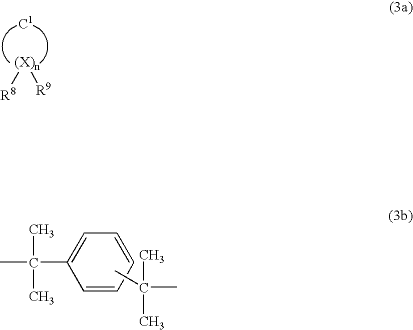

wherein
R⁸ and R⁹ may be chosen individually for each X¹ and independently of one another denote hydrogen or C₁ to C₆-alkyl, preferably hydrogen, methyl or ethyl, and
X¹ denotes carbon and
n denotes an integer from 4 to 7, preferably 4 or 5, with the proviso that on at least one atom X¹, R⁸ and R⁹ are simultaneously alkyl.

Examples of dihydroxyaryl compounds are: dihydroxybenzenes, dihydroxydiphenyls, bis-(hydroxyphenyl)-alkanes, bis-(hydroxyphenyl)-cycloalkanes, bis-(hydroxyphenyl)-aryls, bis-(hydroxyphenyl) ethers, bis-(hydroxyphenyl) ketones, bis-(hydroxyphenyl) sulfides, bis-(hydroxyphenyl) sulfones, bis-(hydroxyphenyl) sulfoxides, 1,1′-bis-(hydroxyphenyl)-diisopropylbenzenes and nucleus-alkylated and nucleus-halogenated compounds thereof.

Aromatic dihydroxy compounds which are suitable for the preparation of the polycarbonates to be used according to the invention are, for example, hydroquinone, resorcinol, dihydroxydiphenyl, bis-(hydroxyphenyl)-alkanes, bis-(hydroxyphenyl)cycloalkanes, bis-(hydroxyphenyl) sulfides, bis-(hydroxyphenyl) ethers, bis-(hydroxyphenyl) ketones, bis-(hydroxyphenyl) sulfones, bis-(hydroxyphenyl) sulfoxides, α,α′-bis-(hydroxyphenyl)-diisopropylbenzenes and alkylated, nucleus-alkylated and nucleus-halogenated compounds thereof.

Preferred diphenols are 4,4′-dihydroxydiphenyl, 2,2-bis-(4-hydroxyphenyl)-1-phenyl-propane, 1,1-bis-(4-hydroxyphenyl)-phenyl-ethane, 2,2-bis-(4-hydroxyphenyl)propane, 2,4-bis-(4-hydroxyphenyl)-2-methylbutane, 1,3-bis-[2-(4-hydroxyphenyl)-2-propyl]benzene (bisphenol M), 2,2-bis-(3-methyl-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl) sulfone, 2,4-bis-(3,5-dimethyl-4-hydroxyphenyl)-2-methylbutane, 1,3-bis-[2-(3,5-dimethyl-4-hydroxyphenyl)-2-propyl]-benzene and 1,1-bis-(4-hydroxyphenyl)-3,3,5-trimethylcyclohexane (bisphenol TMC).

Particularly preferred diphenols are 4,4′-dihydroxydiphenyl, 1,1-bis-(4-hydroxyphenyl)-phenylethane, 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane (bisphenol TMC).

These and further suitable diphenols are described e.g. in U.S. Pat. Nos. 2,999,835, 3,148,172, 2,991,273, 3,271,367, 4,982,014 and 2,999,846, in the German Offenlegungsschriften 1 570 703, 2 063 050, 2 036 052, 2 211 956 and 3 832 396, the French Patent Specification 1 561 518, in the monograph “H. Schnell, Chemistry and Physics of Polycarbonates, Interscience Publishers, New York 1964, p. 28 et seq.; p. 102 et seq.” and in “D. G. Legrand, J. T. Bendler, Handbook of Polycarbonate Science and Technology, Marcel Dekker New York 2000, p. 72 et seq.”.

In the case of the homopolycarbonates, only one aromatic dihydroxy compound is employed, and in the case of copolycarbonates two or more such compounds are employed. The diphenols used, like all other chemicals and auxiliary substances added to the synthesis, may be contaminated with the impurities originating from their own synthesis, handling and storage. However, it is desirable to use raw materials which are as pure as possible.

The monofunctional chain terminators required for regulating the molecular weight, such as phenol or alkylphenols, in particular phenol, p-tert-butylphenol, iso-octylphenol, cumylphenol, chlorocarbonic acid esters thereof or acid chlorides of monocarboxylic acids or mixtures of these chain terminators, are either fed with the bisphenolate or the bisphenolates to the reaction or added to the synthesis at any desired point in time, as long as phosgene or chlorocarbonic acid end groups are still present in the reaction mixture or, in the case of acid chlorides and chlorocarbonic acid esters as chain terminators, as long as sufficient phenolic end groups of the polymer forming are available. Preferably, however, the chain terminator or terminators are added after the phosgenation, at a place or at a point in time when phosgene is no longer present but the catalyst has not yet been metered in, or they are metered in before the catalyst, together with the catalyst or in parallel thereto.

In the same manner, any branching agents or branching agent mixtures may be added to the synthesis, but conventionally before the chain terminators. Trisphenols, quaternary phenols or acid chlorides or tri- or tetracarboxylic acids, or also mixtures of the polyphenols or of the acid chlorides, are conventionally used.

Some of the compounds which have three or more phenolic hydroxyl groups may be used are, for example,
phloroglucinol,
4,6-dimethyl-2,4,6-tri-(4-hydroxyphenyl)-hept-2-ene,
4,6-dimethyl-2,4,6-tri-(4-hydroxyphenyl)-heptane,
1,3,5-tri-(4-hydroxyphenyl)-benzene,
1,1,1-tri-(4-hydroxyphenyl)-ethane,
tri-(4-hydroxyphenyl)-phenylmethane,
2,2-bis-(4,4-bis-(4-hydroxyphenyl)-cyclohexyl]-propane,
2,4-bis-(4-hydroxyphenylisopropyl)-phenol,
tetra-(4-hydroxyphenyl)-methane.

Some of the other trifunctional compounds are 2,4-dihydroxybenzoic acid, trimesic acid, cyanuric chloride and 3,3-bis-(3-methyl-4-hydroxyphenyl)-2-oxo-2,3-dihydroindole.

Preferred branching agents are 3,3-bis-(3-methyl-1,4-hydroxyphenyl)-2-oxo-2,3-dihydroindole and 1,1,1-tri-(4-hydroxyphenyl)-ethane.

The catalysts used in the phase interface synthesis are tertiary amines, in particular triethylamine, tributylamine, trioctylamine, N-ethylpiperidine, N-methylpiperidine and N-i/n-propylpiperidine; quaternary ammonium salts, such as tetrabutylammonium/tributylbenzylammonium/tetraethylammonium hydroxide/chloride/bromide/hydrogen sulfate/tetrafluoroborate; and the phosphonium compounds corresponding to the ammonium compounds. These compounds are described as typical phase interface catalysts in the literature, are commercially obtainable and are familiar to the person skilled in the art. The catalysts may be added to the synthesis individually, in a mixture or also side by side and successively, optionally also before the phosgenation, but meterings after the introduction of phosgene are preferred, unless an onium compound or mixtures of onium compounds are used as catalysts, in which case an addition before the metering of phosgene is preferred. The catalyst or catalysts may be metered in bulk, in an inert solvent, preferably that of the polycarbonate synthesis, or also as an aqueous solution, and in the case of the tertiary amines then as ammonium salts thereof with acids, preferably mineral acids, in particular hydrochloric acid. If several catalysts are used or part amounts of the total amount of catalysts are metered, various methods of metering may of course also be carried out at various places or at various times. The total amount of catalysts used is between 0.001 to 10 mol %, based on the moles of bisphenols employed, preferably 0.01 to 8 mol %, particularly preferably 0.05 to 5 mol %.

The conventional additives may also be added in the conventional amounts to the material according to the invention. The addition of additives serves to prolong the useful life or the color (stabilizers), simplify processing (e.g. mold release agents, flow auxiliaries, antistatics) or adapt the polymer properties to particular stresses (impact modifiers, such as rubbers; flameproofing agents, coloring agents, glass fibres).

These additives may be added to the polymer melt individually or in any desired mixtures or several different mixtures, and in particular directly during isolation of the polymer or after melting of granules, in a so-called compounding step. In this context, the additives or mixtures thereof may be added to the polymer melt as a solid, i.e. as a powder, or as a melt. Another method of metering is the use of masterbatches or mixtures of masterbatches of the additives or additive mixtures. Suitable additives are described, for example, in “Additives for Plastics Handbook, John Murphy, Elsevier, Oxford 1999” and in “Plastics Additives Handbook, Hans Zweifel, Hanser, Munich 2001”.

Preferred heat stabilizers are, for example, organic phosphites, phosphonates and phosphanes, usually those in which the organic radicals consist entirely or partly of optionally substituted aromatic radicals. UV stabilizers which are employed are e.g. substituted benzotriazoles. These and other stabilizers may be used individually or in combination and added in the forms mentioned to the polymer.

Processing auxiliaries, such as mold release agents, usually derivatives of long-chain fatty acids, may moreover be added. Pentaerythritol tetrastearate and glycerol monostearate e.g. are preferred. They are employed by themselves or in a mixture, preferably in an amount of from 0.02 to 1 wt. %, based on the weight of the composition.

Suitable flame-retardant additives are phosphate esters, i.e. triphenyl phosphate, resorcinol-diphosphoric acid esters, bromine-containing compounds, such as brominated phosphoric acid esters and brominated oligocarbonates and polycarbonates, and, preferably, salts of fluorinated organic sulfonic acids.

Suitable impact modifiers are, for example, graft polymers comprising one or more graft bases chosen from at least one polybutadiene rubber, acrylate rubber (preferably ethyl or butyl acrylate rubber) and ethylene/propylene rubbers, and graft monomers chosen from at least one monomer from the group consisting of styrene, acrylonitrile and alkyl methacrylate (preferably methyl methacrylate), or interpenetrating siloxane and acrylate networks with grafted-on methyl methacrylate or styrene/acrylonitrile.

Coloring agents, such as organic dyestuffs or pigments or inorganic pigments, IR absorbers, individually, in a mixture or also in combination with stabilizers, glass fibres, glass (hollow) beads and inorganic fillers, may furthermore be added.

The present application furthermore provides the extrudates and moldings obtainable from the substrate materials according to the invention, in particular those for use in the transparent sector, very particularly in the optical uses sector, such as e.g. sheets, multi-wall sheets, glazing, diffusing screens and lamp covers, or optical data storage media, such as audio-CD, CD-R(W), DVD, DVD-R(W) and minidisks in their various only readable or once writable and optionally also repeatedly writable embodiments.

The present invention furthermore provides the use of the materials according to the invention for the production of extrudates and molded articles.

The substrate material according to the invention, preferably polycarbonate, may be processed by injection molding by known processes. A disk produced in this way may be e.g. an audio-CD or a super-audio-CD, CD-R, CD-RW, DVD, DVD-R, DVD+R, DVD-RW, DVD+RW or BR.

The CD-R (write once, read many) thus comprises a substrate having concentrically formed guide depressions (pregrooves) which are transferred from a nickel template in the injection molding process. Via a template which has depressions on a sub-micrometre scale, these are transferred accurately to the surface of the substrate in the injection molding process. The CD-R comprises the abovementioned substrate, a dyestuff recording layer, a reflection layer and protective layer, which are applied or laminated on to the substrate in this sequence. Another example for a once-writable optical disk which may be read again several times is the DVD-R, which comprises the substrate, a dyestuff recording layer, a reflection layer and optionally a protective layer which are likewise applied in this sequence to the substrate described above and are glued with a second disk (“dummy disk”).

The dyestuff layer is applied via a “spin coating” process. In this production step, the particular dyestuff, dissolved in an organic solvent, is applied to the information layer of the substrate and introduced uniformly in the radial direction into the depressions of the substrate by rotation of the disk. After this step, the dyestuff layer is dried.

The dyestuff to be used for the use described above has an absorption range which lies in the range of the laser used (300-850 nm). Examples of dyestuff types are e.g. cyanines, phthalocyanines, squarylium dyestuffs, polymethines, pyrilium and thiopyrilium dyestuffs, indoanilines, naphthoquinones, anthraquinones and various metal-chelate complexes, such as e.g. azo coordination compounds, cyanines or phthalocyanines. These dyestuffs have a good signal sensitivity and good solubility in organic solvents and light-fastness and are therefore preferred dyestuffs for the uses described above.

Examples of solvents are esters, such as butyl acetate, ketones, such as methyl ethyl ketone, cyclohexanone, methyl isobutyl ketone and 2,4-dimethyl-4-heptanone (DMH), chlorinated hydrocarbons, such as 1,2-dichloroethane and chloroform, amides, such as dimethylformamide, hydrocarbons, such as cyclohexane, methylcyclohexane or ethylcyclohexane, ethers, such as THF and dioxane, alcohols, such as ethanol, propanol, isopropanol, n-butanol and diacetone alcohol, fluorinated solvents, such as 2,2,3,3-tetrafluoropropanol, and glycol ethers, such as ethylene glycol monomethyl ether and propylene glycol monomethyl ether. These may be employed individually or as mixtures. Preferred solvents are fluorinated solvents, such as 2,2,3,3-tetrafluoropropanol, octafluoropentanol and dibutyl ether.

A reflection layer, e.g. comprising gold or silver, may be applied to the dyestuff layer via a sputtering method. A protective layer may optionally be applied to the reflection layer.

The disk substrate according to the invention and the optical disk according to the invention show clearly improved antistatic properties and improved coatability.

The injection-molded article is obtained by conventional injection molding processes. In demonstrating the invention, see below, the injection-molded article was produced as follows:

In preparing an optical disk according to the invention; the following injection molding parameters and conditions prevailed:
Machine: Netstal Discjet
Template: Audio stamper
Cycle time: 4.4 seconds
Melt temperature: 310-330° C.
Substrate dimensions: Audio-CD
Mold temperature on the template side: 60° C.

Before the start of the injection molding process, a new audio stamper was inserted into the machine. Before the new stamper was inserted, the entire injection molding unit was cleaned from the preceding material to assure correct measurements. Furthermore, any ionizers present must be switched off, that the measurement results are not adulterated.

The method for measurement of the surface potential was carried out via a Monroe probe (available from MONROE ELECTRONICS, INC., Lyndonville, N.Y. 14098, USA) suitable for measurement of electrical potentials. The measurement was carried out at a distance of 3.5 mm from the substrate surface. The scanning range was in each case 12 cm in the X- and Y-direction. The surface potential was measured in steps of in each case 2 mm in the X- and Y-direction. The potential values were converted into an equivalent voltage value at the analogue output of the measuring amplifier of the Monroe probe. These potential values were initially stored in a PC from the analogue input of a PC interface card from BurrBrown by means of software developed in-house (TurboPascal) using TurboPascal routines from BurrBrown and, after scanning, the entire data were stored as a text file on diskette. For better visual illustration of the measurement values, the values were converted into a false color image by means of Origin software. The potential range from −3,500 V to +3,500 V is divided here into 32 color ranges. The colors passed from blue via green and yellow to red. For example, the most negative potential range of −3,500 V to −3,281 V was assigned the color dark blue, and the most positive potential range of +3,281 V to +3,500 V was assigned the color dark red.

To calculate the charge segments, the measurement values (raw data) were converted into Cartesian coordinates in a value range of from −30 to +30. These values were then converted into planar polar coordinates. In order to record only the relevant area, all values where r<12 mm (inner hole region) or r>59 mm were not considered. The values which then result were sorted into the corresponding charge ranges and counted.

The disks were measured in respect of the distribution of the potential within the first 24 hours after production. During this procedure, the disk must not come into contact with metal, since otherwise the potential measurement is impaired.

When carrying out the measurement, it is to be ensured that the atmospheric humidity during the measurement is 30 to 60%, preferably 35 to 50%, and the room temperature is 25 to 28° C.

The dyestuff application may be carried out via “spin coating” as described above. A phthalocyanine is preferably used as the dyestuff and dibutyl ether is preferably used as the solvent. The speed of rotation during application of the dyestuff is 200 rpm. To distribute the solution over the entire disk, the speed is increased to 5,000 rpm.

The coatability with dyestuff may be measured e.g. by visual examination, by a camera scanner or by light microscopy examination of the inner region of the disk coated with dyestuff. If a deviation from the color edge of 0.5 mm or higher is found at a place of the outer dyestuff edge, the wetting properties of this disk are deemed inadequate.

A further indirect means of measuring the coatability is that of checking the disk coated e.g. with dyestuff with a camera or laser system. In this case, the information recorded is evaluated via image processing software and wetting errors which occur are recognized (“in-line” detection). Defective disks are automatically discarded.

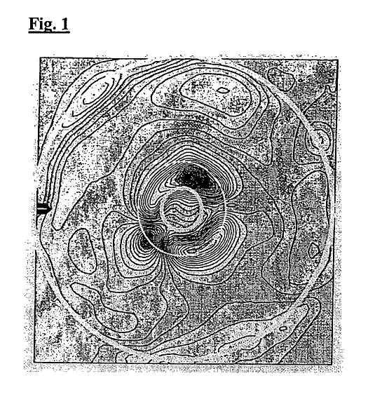

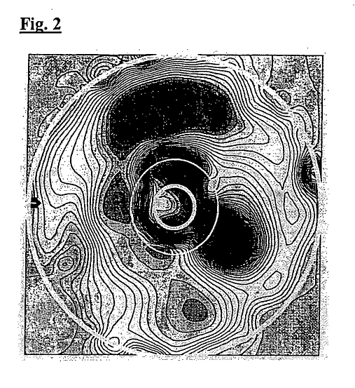

FIGS. 1 and 2 show the charge distribution of a disk (black and white copy of the false color image).

### EXAMPLES

### Example 1

The polycarbonate is prepared by the known phase interface process. A continuous process is used.

The bisphenolate solution (bisphenol A; alkali content 2.12 mol NaOH/mol BPA) was fed into the reactor at 750 kg/h (14.93 wt. %), the solvent (methylene chloride/chlorobenzene 1:1) at 646 kg/h and the phosgene at 56.4 kg/h and the components were reacted. The temperature in the reactor was 35° C. Sodium hydroxide solution (32 wt. %) was also metered in at 9.97 kg/h. In the course of the condensation reaction, a second amount of sodium hydroxide solution (32 wt. %) was metered in at 29.27 kg/h, as well as a solution of chain terminators (11.7 wt. % tert-butylphenol in methylene chloride/chlorobenzene 1:1) at 34.18 kg/h. Thereafter, N-ethylpiperidine, dissolved in methylene chloride/chlorobenzene (1:1; 2.95 wt. % N-ethylpiperidine) was fed in at 33.0 kg/h as a catalyst. The phases were separated and the organic phase washed once with dilute hydrochloric acid and five times with water. The polycarbonate solution was then concentrated, the concentrate was concentrated in an evaporating tank and the polymer melt spun off via a devolatilization extruder and granulated.

The granules obtained were processed to disks via a Netstal Discjet injection molding machine (see above) at a cycle time of 4.4 seconds under the abovementioned parameters. An audio stamper was used as the template.

The result of the potential measurement of a disk after 2 hours of a continuous injection molding process is shown in FIG. 1.

TABLE 1
(evaluation of FIG. 1)

| | | % content of the |
|---|---|---|
| | | charge segments, |
| | Number of charge | based on the |
| Charge segments | segments | total area |
| >+2.5 | 0 | 0.00 |
| +1.5 to +2.5 kV | 0 | 0.00 |
| +0.5 to +1.5 kV | 112 | 5.28 |
| −0.5 to +0.5 kV | 1,569 | 74.01 |
| −1.5 to −0.5 kV | 434 | 20.47 |
| −2.5 to −1.5 kV | 5 | 0.24 |
| <−2.5 | 0 | 0.00 |

It may be seen that the charge distribution is very uniform.

The disks were coated in the spin coating process as described above with a phthalocyanine dissolved in dibutyl ether. The speed of rotation during application of the dyestuff was 200 rpm. To distribute the solution over the entire disk, the speed was increased to 5,000 rpm. Visual assessment showed no defects of the dyestuff layer.

### Example 2

### (Comparison Example)

The polycarbonate was prepared as described in Example 1. However, the bisphenolate solution (bisphenol A) was fed into the reactor at 750 kg/h (14.93 wt. %), the solvent (methylene chloride/chlorobenzene 1:1) at 646 kg/h and the phosgene at 58.25 kg/h. Sodium hydroxide solution (32 wt. %) was likewise metered in at 12.34 kg/h. The second amount of sodium hydroxide solution was metered at 36.20 kg/h; the amount of chain terminators was introduced at 34.18 kg/h at the concentrations stated in Example 1. The amount of catalyst was metered at a rate of 33 kg/h. Working up was carried out as described in Example 1.

The granules obtained were then processed to disks via a Netstal Discjet injection molding machine (see above) at a cycle time of 4.4 seconds under the abovementioned parameters. An audio stamper is used as the template.

Clear defects in the dyestuff layer were found on disks coated with dyestuff.

TABLE 2
(evaluation of FIG. 2)

| | | % content of the |
|---|---|---|
| | | charge segments, |
| | Number of charge | based on the |
| Charge segments | segments | total area |
| >+2.5 | 395 | 18.70 |
| +1.5 to +2.5 kV | 692 | 32.77 |
| +0.5 to +1.5 kV | 728 | 34.47 |
| −0.5 to +0.5 kV | 200 | 9.47 |
| −1.5 to −0.5 kV | 31 | 1.47 |
| −2.5 to −1.5 kV | 15 | 0.71 |
| <−2.5 | 51 | 2.41 |

TABLE 3

| | Charge | | |
|---|---|---|---|
| | homogeneity | Surface potential | |
| | (standard | charge peaks (pos. | Defects at the |
| Ex. No.: | deviation) | and negative) | inner edge |
| 1 | 0.41 | +1.5/−2.5 | no |
| 2 (comp.) | 1.21 | >+3.5/<−3.5 | yes |

The standard deviation is the variance of the individual charge segments.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. Polymeric material suitable for making a substrate for optical data storage disk, characterized in that the potential on 95 to 100% of the total surface of a disk molded therefrom is from −1.5 to +1.5 kV, and in that the potential on 0 to 5% of the total surface of said disk is between −1.5 and −2.5, and +1.5 to +2.5, and in that the potential on no more than 1% of the total surface of said disk is less than −2.5 kV and more than +2.5 kV, wherein the potential measurements are carried out by means of a Monroe probe at a distance of 3.5 mm from the surface of the disk, the scanning region is in each case 12 cm in the X- and Y-direction, and in each case in steps of 2 mm in the X- and in the Y-directions.

2. Polycarbonate suitable for making a substrate for optical data storage disk, characterized in that the potential on 95 to 100% of the total surface of a disk molded therefrom is from −1.5 to +1.5 kV, and in that potential on 0 to 5% of the total surface of said disk is between −1.5 and −2.5, and +1.5 to +2.5, and in that the potential on no more than 1% of the total surface of said disk is less than −2.5 kV and more than +2.5 kV wherein the potential measurements are carried out by means of a Monroe probe at a distance of 3.5 mm from the surface of the disk, the scanning region is in each case 12 cm in the X- and Y-direction, and in each case in steps of 2 mm in the X- and in the Y-directions.

3. Polymeric material according to claim 1, characterized in that on the corresponding moulding the standard deviation of the potential resulting from the electrical charging in the charge segments does not exceed 0.6 kV.

4. An optical data storage medium comprising the polymeric material of claim 1.

5. An optical data storage medium comprising the polycarbonate of claim 2.
